(19) United States
(12) Patent Application Publication
(10) Pub. No.: US 2005/0025893 A1
(43) Pub. Date: Feb. 3, 2005

(54) Composite tool coating system

(76) Inventor: Clifford L. Smith, Oklahoma City, OK (US)

Correspondence Address: LAW OFFICE OF CRAIG BOHN, 2134 BRANARD STREET, HOUSTON, TX, 77098, US

(21) Appl. No.: 10/798,768

(22) Filed: Mar. 11, 2004

Related U.S. Application Data
(60) Provisional application No. 60/491,384, filed on Jul. 31, 2003.

(51) Int. Cl. B05D 1/36

(52) U.S. Cl. 427/421.1; 427/402

(57) ABSTRACT

My invention is a sequentially applied composite coating process that combines plate coating and spray coating techniques into an integrated system. A component, or part, is plated with a suitable material to build up surfaces of the part to a desired prepared specification. The part is then coated with a second molten material sprayed on, integrally bonding the spray-coating material into the plated-coating material layer of the part, to achieve the final spray coated composite material. Final grinding and/or polishing finish preparation may follow. Various materials and/or blends of materials known to the field of each individual art may be used in the plating stage and the spraying stage. In this fashion a relatively thick coating of highly durable material may be applied with superior bonding properties than achievable through currently practiced methods.

### CROSS-REFERENCE TO RELATED APPLICATIONS

This application claims the benefit of U.S. Provisional Application No. 60/491,384, filed Jul. 31, 2003.

### STATEMENT REGARDING FEDERALLY SPONSORED RESEARCH OR DEVELOPMENT

Not Applicable.

### BACKGROUND OF THE INVENTION

1. Field of the Invention

The invention is generally related to creating or repairing the service area of components and more specifically to creating a composite exterior component coating through the sequential application of various coating materials applied by differing application techniques and equipment.

2. Description of the Related Art

Various types and techniques of metal finishing are known in the field. Metal finishing is applied usually to the area of a component subjected to unique or severe service as metal finishes have unique properties that for many reasons are not wanted throughout the entire component.

Components in a wide variety of industrial applications experience unique or severe service in a specific region. Metal finish coatings have been found to increase the durability of the service region. Such coatings may be included in original manufacture of the particular component, or may also be applied in a refurbishment process, where a worn component is repaired and remanufactured to perform in a similar capacity as originally intended.

Plating is a known technique used to apply metal finishes to part service areas. Many variations exist. A typical plating process consists of preparation of the item to be plated. Preparation may include one or more processes such as cleaning, grinding, stripping, polishing, blasting, and baking. The component may then be put in a rack in order to securely attached one pole of a potential power supply to the component. Racking typically includes masking, where portions of the component where plating material is not desired are covered with a material to which the plating material will not affix, so the covered areas do not receive plating material.

The component is then inserted into a metal solution bath, which is attached to the other pole of the power supply. Power is applied for a duration and intensity as determined by the materials, as known in the field. After the power is shut off, the component is removed from the metal solution bath and is post-plating finished. This finishing may include one or more processes such as cleaning, grinding, polishing, super-finishing, blasting, baking, and inspection for size and shape conformity.

Spray metal coating is another known coating technique used to apply metal finishes to part service areas. This technique has gained importance in chromium replacement efforts. Many variations exist, including powder, plasma, laser, wire, thermal arc, and high-velocity oxygen fueled (HVOF). A typical general spray coating process consists of preparation of the item to be plated. Preparation may include one or more processes such as cleaning, grinding, stripping, polishing, blasting, and baking. A component to be sprayed may then be set in a spinner so that the part may spin to present a circumferential service area to a spray gun, mounted in a specific distance from the service area surface, and a fixed position, in relationship to the rotation. The component may be rotated and molten material from the gun may be applied to the service area surface, with either the gun or the component moving a slight distance laterally such that each spray circumferential band appropriately joins with the circumferential band applied the rotation prior. This continues until a layer of coating material covers entire length of the service area. Flat or uniquely shaped items may not work well with the rotation method, so robots or other various fixtures may be used to apply the spray in uniform patterns on items of assorted shapes.

The component may then be post-spraying finished. This finishing may include one or more processes such as cleaning, grinding, polishing, super-finishing, blasting, baking, and inspection for size and shape conformity. The initial layer of coating material is typically of uniform thickness. Multiple layers of the same or varying materials may be applied to create a desired thickness, or a greater thickness that may then be ground to the desired dimensions.

Each spray coating technique has advantages and disadvantages. One consistent disadvantage, as compared to plating, is the high cost to apply relatively thick coatings by these techniques. Another consistent disadvantage, as compared to plating, is that spray coatings frequently experience a bonding failure, either or both between the coating and the base metal, or between multiple layers of coatings applied to achieve thickness.

It would be an improvement to the field of art to provide a composite coating technique that employs known coating methods and materials in a structural combination that results in superior durability and bonding, while permitting cost effective application of a relatively thick total coating to severe service areas. Considering all the related costs of suspending operation to pull a worn component from service, even slight improvements in durability may be significant, but substantial improvements are momentous. Additionally, the process provides superior results with the use of various coating materials, permitting the elimination of chromium plating—an important factor since environmental issues regarding the use of chromium has become an increasing concern.

### BRIEF SUMMARY OF THE INVENTION

My invention is a sequentially applied composite coating process that combines plate coating and spray coating techniques into an integrated system that provides superior durability. A component, or part, is plated with a suitable material, achieving a metallurgical bond to the surfaces of the part, to a desired prepared specification. The part is then coated with a molten material sprayed on, integrally bonding the spray-coating material into the plated-coating material layer of the part, to achieve the final spray coated composite material. The proper choice of the plated coating provides superior bonding to the base metal and may also allow for a superior bond of the sprayed metal. Final grinding and/or polishing finish preparation may follow. Various materials and/or blends of materials known to the field of each individual art may be used in the plating stage and the spraying stage. In this fashion a relatively thick coating of highly durable material may be applied with superior bonding properties than achievable through currently practiced methods.

The process may be adapted to both an initial manufacturing process and a process for reconditioning tools. In preparation for plating, a surface of a part is manufactured, ground, or machined to make the existing surface into the proper shape. The part is then ready to receive the initial plate coating. The plate coating step may include the application of multiple layers of plating material and intermediate steps to produce the desired shape and size of the part, to meet tolerance requirements of the specific application. Allowances are made in the desired dimensions to accommodate the thickness of the subsequent spray coating layer. With the application of the spray coating, the piece achieves the desired dimensions required by the particular specification or application.

In the manufacture of new parts, the basic part is created to meet the desired size and shape of the finished part, minus the thickness of the desired total composite coating. The plate coating and then the spray coating may be applied as described above for a used part. The particular desired thickness of each coating may be determined specifically for the particular situation. A final finishing step comprising of grinding and/or polishing to a super finish may complete the process.

### BRIEF DESCRIPTION OF THE DRAWINGS

FIG. 1 is an exemplary component having a service area suitable for metal finishing in accordance with the present invention.

FIGS. 2 through 7 are intended to illustrate the nature of typical wear and orientation of typical layers of coating materials that may be applied to a component and therefore may not show wear damage and coating layer thicknesses to scale.

FIG. 2 is cross-sectional view of the worn service area of the component in FIG. 1, cut at line 2-2.

FIG. 3 depicts the component of FIG. 2 after exemplary removal of the damaged service area.

FIG. 4 depicts the component of FIG. 3 after exemplary initial plating of the service area.

FIG. 5 depicts the component of FIG. 4 after exemplary grinding of the initial plating of the service area.

FIG. 6 depicts the component of FIG. 5 after application of an exemplary spray coating to the service area.

FIG. 7 depicts the component of FIG. 6 after exemplary final finishing.

FIG. 8 depicts the primary steps of the inventive process.

### DESCRIPTION OF THE INVENTION

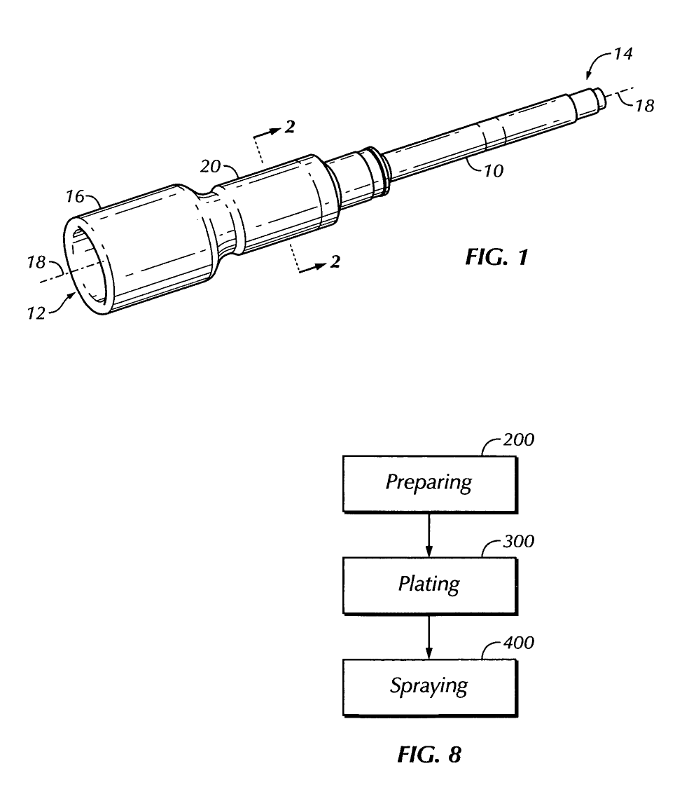

As shown in FIG. 1, a typical component 10, or part, suitable for coating with the process of this invention is often elongatedly cylindrical in shape. Modification to the process may be made in order to permit the coating of parts having various shapes without departing from the spirit of the invention. The exemplary component 10 is a mandrel for a shock sub having a head end 12, a spline end 14, a hollow core 16 and a linear axis 18. Intermediate head end 12 and spline end 14 is a service area 20 coaxially circumferential at the exterior of component 10.

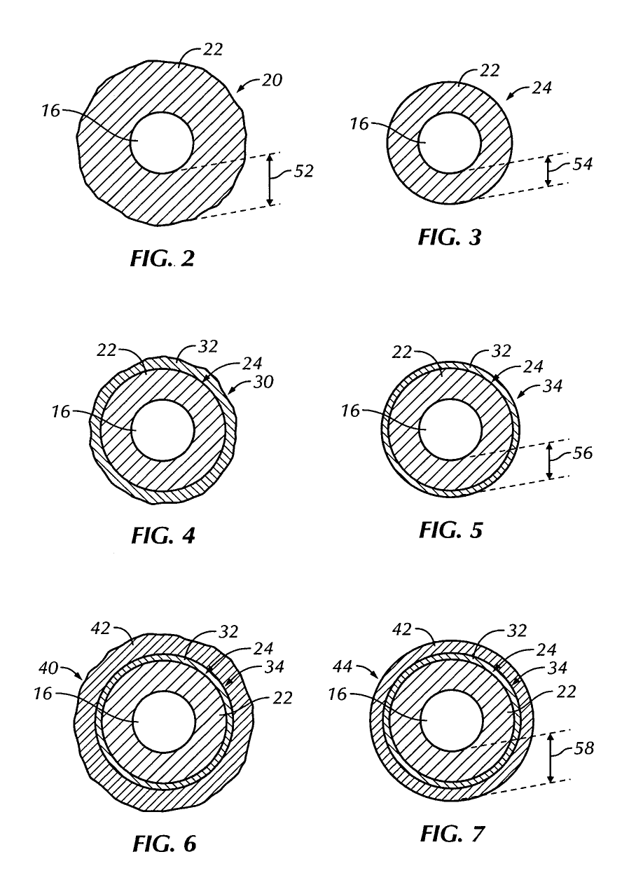

Referring to FIG. 2, service area 20 is the outer surface of base metal tool 22. In a worn state, service area 20 may have irregularities, which may be parallel, circumferential or isometric of linear axis 18, giving service area 20 an uneven, inconsistent surface, making the component unsuitable for continued use. Service area 20 has tool service area thickness 52.

Referring to FIGS. 3 and 8, the first step, preparing step 200 of the process is to produce a uniform base metal surface 24. Many suitable methods for achieving uniform base metal surface 24 are known to the field and the method used may depend on the specific dimensions and base metal of base metal tool 22. Methods of preparation are known in the art. Service area 20 should be suitably prepared for whichever process of achieving uniform base metal surface 24. Such preparation may include one or more processes such as abrading, to include, machining, grinding, stripping, and polishing, and cleaning. Preparing step 200 results in a tool service area with a beginning tool service area thickness 54 devoid of foreign substances or material.

Referring to FIGS. 4 and 8, the next step, plating step 300, comprises applying a primary coating 32 by a plating process, as know in the prior art. The exemplary electroplating bath process described above employing a nickel sulfomate bath provides suitable results. The resulting plate metal surface area 30 may be transitionally finished by one or more processes, which may include, but is not limited to, cleaning, grinding, machining, polishing, and baking. Referring to FIG. 5, the result is uniform plate metal surface 34. Uniform plate metal surface 34 may be inspected or evaluated for suitable dimensions, cleanliness and uniformity in compliance with plate layer requirements. Plating step 300 may include repeating the process of plating step 300 to correct irregularities in uniform plate metal surface 34 and to achieve a tool service area 20 of a desired plate coating thickness 56. Suitable preparations for repeating plating step 300 may include grinding a significant portion of primary coating 32 in order to achieve suitable dimensional and quality results from repeating plating step 300.

Referring to FIGS. 6 and 8, the next step, spraying step 400, comprises applying an outer coating 42 by a spray metal process, as know in the prior art. The exemplary spray metal process described above employing a high-velocity oxygen fueled spray gun provides suitable results. The resulting spray metal surface area 40 may be transitionally finished by one or more processes to remove inconsistencies in, which may include, but is not limited to, abrading, cleaning, grinding, polishing, super-finishing, and baking. The result is uniform spray metal surface 44, and a tool service area 20 of a desired spray coating thickness 58 that is highly durable and securely bonded to base metal tool 22.

It is believed that the initial plate, applied in plating step 300, provides a metallurgical bond, which, when covered with an appropriate mechanically bonded spray coating in spraying step 400, provides the superior stability of the composite coating to the tool surface. The proper choice of plating material, such as nickel sulfamate, increased the benefit of the plating bond to the base metal of the tool.

Uniform spray metal surface 44 may be inspected for suitable dimensions, cleanliness and uniformity in compliance with spray layer requirements. Spraying step 400 may include repeating the process of spraying step 300 to correct irregularities in uniform spray metal surface 44. Suitable preparations for repeating spraying step 400 may include grinding a significant portion of outer coating 42, to the point of removing virtually all outer coating 42 in order to achieve suitable bonding, dimensional and quality results from repeating spraying step 400.

### EXAMPLE #1

The exemplary subject part is a portion of “down hole” oil field drilling tool commonly called a “shock sub” or typically just called a “mandrel.” (See FIG. 1.) The exemplary part is approximately 72 inches long with diameters varying from 5.5 to 12 inches. The portion that requires metal finishing for corrosion resistances wear and seal purposes is 5.5 inches diameter by 11 inches long. The part had been subjected to prior use and was a repair project.

In the first step, the portion to receive metal finishing was ground undersized to remove the prior metal finish as well as to remove all imperfections. It was necessary to grind the part 128 thousandths of an inch undersized before it was true and round with imperfections removed, and before it was ready to plate. It is known to the field that grinding in excess of 120 thousandths of an inch has proven to cause bonding problems and brittleness in metal refinishing. The part was then baked per ISO specification.

The part was then prepared for the next step of nickel plating by cleaning, blasting, and etc. The part was then plated to 5.515 inches, which is 15 thousandths of an inch over the final finish size with nickel sulfamate. Nickel sulfamate provides an extremely good bond, induces minimal stress to the parts and is an excellent undercoat for corrosion resistance. The part was then baked after plating for hydrogen relief per ISO standards for industrial nickel plating.

The part was ground to the proper size to allow for the final spray metal finish. We choose to spray the part with a thickness of approximately 10 thousandths of an inch. We choose a WC-79/CO-10/Cr-5, containing mostly tungsten carbide, which has an extremely hard surface. We also limited the thickness to 10 thousandths of an inch, as the industry had consistently reported bonding problems and brittleness with thick, hard spray metal surfaces.

In the next principle step, a HVOF spray was then applied to the part. The part was then finished ground to 5.5 inches, 000-0.002 inch, providing a final thickness of 9-10 thousandths of an inch of the WC-79/CO-10/Cr-5 (TAFA 1350 product) spray metal coating. We required a 3-5 RMS finish, as we wanted as smooth a finish as practical, because the coefficient of friction of the tungsten carbide was not as good as the traditionally used hard chromium.

At this point the part was ready for field testing. After six (6) trial runs “down hole” the part showed little wear. The part far exceeded expectations and gave the impression that the splines may wear out before the metal finish.

### EXAMPLE #2

The tool in example #1 has 10 thousandths of an inch of HVOF spray metal with tungsten carbide. The tool in example #2 was given a thinner top coat of approximately 5 thousandths of an inch thickness. This is ½ the thickness of the prototype in Example #1.

This part is the same type mandrel for a “shock sub” and was prepared in the same manner as the first part, except the electroplated nickel undercoat was finished to allow for only 5 thousandths of an inch thickness of the top coat. The same WC-79/CO-10/Cr-5 tungsten carbide cobalt, chrome top coat (TAFA 1350 product) was applied in the same fashion. At that point it was ready for field testing.

In the field tests this part, like the part in example #1, has significantly exceeded the service duration anticipated in excess of known metal finishing processes.

Though the disclosure has used the exemplary embodiment of a single type of base-metal tool prone to wear on a service area, it is understood that the invention goes beyond this single application. Other tools of various shapes and sizes may receive extended functionality by the current method of rebuilding the particular tool's service area. The cylindrical shaped tool is merely an exemplary embodiment and not intended to limit the scope of the process. The actual shape of tools that may be coated is limited only by the quality of the particular coating equipment being used and skill employed by the coating operators.

The present invention is directed to a composite tool coating method for a tool service area having a tool service area thickness and tool serviceability requirements, said method comprising preparing said tool service area for coating, said tool service area having a beginning said stool service area thickness, plating at least one layer of plate coating material to said prepared tool service area, said at least one layer of plate coating material having a plate coating thickness, a plated service area thickness equaling said beginning tool service area thickness plus said plate coating thickness, and spraying at least one layer of spray coating material to said at least one layer of plate coating material, said at least one layer of spray coating material having a spray coating thickness, a sprayed service area thickness equaling said plated service area thickness plus said spray coating thickness. Other variations of this embodiment include said preparing step further comprising cleaning said tool service area, abrading said tool service area to remove inconsistencies and reduce said tool service area thickness to said beginning tool service area thickness as needed, said plating step further comprising at least one transitional finishing step to remove inconsistencies in said at least one layer of plate coating material, said transitional finishing step further comprising abrading said at least one layer of plate coating material to remove inconsistencies and reduce said plate coating thickness to achieve a desired said plated service area thickness, and/or baking said at least one layer of plate coating material, said plating step further comprising at least one subsequent plating step to increase said plate coating thickness and achieve plate layer requirements, and/or at least one transitional evaluating step to inspect said tool service area and said tool service area thickness for compliance with plate layer requirements, said spraying step further comprising at least one transitional finishing step to remove inconsistencies in said at least one layer of spray coating material, and possibly abrading said at least one layer of spray coating material to remove inconsistencies and reduce said spray coating thickness to achieve a desired said sprayed service area thickness, aid spraying step further comprising at least one subsequent spraying step to increase said spray coating thickness and achieve spray layer requirements, at least one transitional evaluating step to inspect said tool service area and said tool service area thickness for compliance with spray layer requirements, said method further comprising a final finishing step after said spraying step to achieve said tool serviceability requirements, cleaning said composite tool coating to remove foreign substances and materials, polishing said composite tool coating to remove slight inconsistencies, and possibly evaluating said composite tool coating, said tool service area and said tool service area thickness for compliance with said tool serviceability requirements. These listed variations may be used in combination as deemed appropriate by one skilled in the art and remain within the scope of the current invention.

An alternate embodiment to the present invention is directed to a composite tool coating method for a tool service area having a tool service area thickness and a tool serviceability requirement, said tool service area having a base metal component and a plate coating layer, said method comprising preparing said tool service area for coating, said tool service area having a beginning said tool service area thickness, and spraying at least one layer of spray coating material to said plate coating layer, said at least one layer of spray coating material having a spray coating thickness, a sprayed service area thickness equaling said beginning tool service area thickness plus said spray coating thickness. Variations listed for the previous embodiment may be used in combination as deemed appropriate by one skilled in the art and remain within the scope of the current invention.

The foregoing disclosure and description of the invention is illustrative and explanatory thereof, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A composite tool coating method for a tool service area having a tool service area thickness and tool serviceability requirements, said method comprising:
preparing said tool service area for coating, said tool service area having a beginning said tool service area thickness;
plating at least one layer of plate coating material to said prepared tool service area, said at least one layer of plate coating material having a plate coating thickness, a plated service area thickness equaling said beginning tool service area thickness plus said plate coating thickness; and
spraying at least one layer of spray coating material to said at least one layer of plate coating material, said at least one layer of spray coating material having a spray coating thickness, a sprayed service area thickness equaling said plated service area thickness plus said spray coating thickness.

2. The method of claim 1 wherein said preparing step further comprising:
cleaning said tool service area.

3. The method of claim 1 wherein said preparing step further comprising:
abrading said tool service area to remove inconsistencies and reduce said tool service area thickness to said beginning tool service area thickness as needed.

4. The method of claim 1 wherein said plating step further comprising:
at least one transitional finishing step to remove inconsistencies in said at least one layer of plate coating material.

5. The method of claim 4 wherein said transitional finishing step further comprising:
abrading said at least one layer of plate coating material to remove inconsistencies and reduce said plate coating thickness to achieve a desired said plated service area thickness.

6. The method of claim 4 wherein said transitional finishing step further comprising:
baking said at least one layer of plate coating material.

7. The method of claim 1 wherein said plating step further comprising:
at least one subsequent plating step to increase said plate coating thickness and achieve plate layer requirements.

8. The method of claim 1 wherein said plating step further comprising:
at least one transitional evaluating step to inspect said tool service area and said tool service area thickness for compliance with plate layer requirements.

9. The method of claim 1 wherein said spraying step further comprising:
at least one transitional finishing step to remove inconsistencies in said at least one layer of spray coating material.

10. The method of claim 9 wherein said transitional finishing step further comprising:
abrading said at least one layer of spray coating material to remove inconsistencies and reduce said spray coating thickness to achieve a desired said sprayed service area thickness.

11. The method of claim 1 wherein said spraying step further comprising:
at least one subsequent spraying step to increase said spray coating thickness and achieve spray layer requirements.

12. The method of claim 1 wherein said spraying step further comprising:
at least one transitional evaluating step to inspect said tool service area and said tool service area thickness for compliance with spray layer requirements.

13. The method of claim 1 further comprising:
a final finishing step after said spraying step to achieve said tool serviceability requirements.

14. The method of claim 13 wherein said final finishing step further comprising:
cleaning said composite tool coating to remove foreign substances and materials.

15. The method of claim 13 wherein said final finishing step further comprising:
polishing said composite tool coating to remove slight inconsistencies.

16. The method of claim 13 wherein said final finishing step further comprising:
evaluating said composite tool coating, said tool service area and said tool service area thickness for compliance with said tool serviceability requirements.

17. A composite tool coating method for a tool service area having a tool service area thickness and a tool serviceability requirement, said tool service area having a base metal component and a plate coating layer, said method comprising:
preparing said tool service area for coating, said tool service area having a beginning said tool service area thickness; and
spraying at least one layer of spray coating material to said plate coating layer, said at least one layer of spray coating material having a spray coating thickness, a sprayed service area thickness equaling said beginning tool service area thickness plus said spray coating thickness.

18. The method of claim 17 wherein said spraying step further comprising:
at least one transitional finishing step to remove inconsistencies in said at least one layer of spray coating material.

19. The method of claim 18 wherein said transitional finishing step further comprising:
abrading said at least one layer of spray coating material to remove inconsistencies and reduce said spray coating thickness to achieve a desired said sprayed service area thickness.

20. The method of claim 17 wherein said spraying step further comprising:
at least one subsequent spraying step to increase said spray coating thickness and achieve spray layer requirements.

21. The method of claim 17 wherein said spraying step further comprising:
at least one transitional evaluating step to inspect said tool service area and said tool service area thickness for compliance with spray layer requirements.

22. The method of claim 17 further comprising:
a final finishing step after said spraying step to achieve said tool serviceability requirements.

23. The method of claim 22 wherein said final finishing step further comprising:
cleaning said composite tool coating to remove foreign substances and materials.

24. The method of claim 22 wherein said final finishing step further comprising:
polishing said composite tool coating to remove slight inconsistencies.

25. The method of claim 22 wherein said final finishing step further comprising:
evaluating said composite tool coating, said tool service area and said tool service area thickness for compliance with said tool serviceability requirements.
